(19) United States
(12) Patent Application Publication
(10) Pub. No.: US 2023/0078948 A1
(43) Pub. Date: Mar. 16, 2023

(54) IMAGE FORMING APPARATUS

(71) Applicant: CANON KABUSHIKI KAISHA, Tokyo (JP)

(72) Inventors: Hiroki Tanaka, Kanagawa (JP); Satoru Motohashi, Chiba (JP); Nobuo Oshima, Tokyo (JP); Akihisa Matsukawa, Tokyo (JP); Katsuichi Abe, Kanagawa (JP); Takayuki Namiki, Kanagawa (JP)

(21) Appl. No.: 17/989,834

(22) Filed: Nov. 18, 2022

Related U.S. Application Data
(62) Division of application No. 17/526,171, filed on Nov. 15, 2021, now Pat. No. 11,526,103.

(30) Foreign Application Priority Data
Dec. 25, 2020 (JP) 2020-218059

(51) Int. Cl. G03G 15/16; G03G 21/10

(52) U.S. Cl. CPC G03G 15/1665; G03G 21/10

(57) ABSTRACT

An image forming apparatus includes a first image forming portion, a second image forming portion, a belt, a charging voltage applying portion, and a transfer voltage applying portion. With respect to a movement direction of a recording material, the first image forming portion is provided upstream of the second image forming portion. In an image forming operation, a potential difference between a first transfer voltage and a potential at a first transfer portion, which is formed on a first image bearing member and does not form the image, is greater than a potential difference between a second transfer voltage and a potential at a second transfer portion, which is formed on a second image bearing member and does not form an image.

Conventionally, as the image forming apparatus of the electrophotographic type, there is an image forming apparatus having a constitution in which an image is formed on a recording material by transferring toner images, formed on a plurality of image bearing members, onto the recording material fed while being carried on a recording material carrying member. In this image forming apparatus, corresponding to each of the image bearing members, a charging member for electrically charging the image bearing member, a developing device for forming the toner image by supplying toner as a developer to the image bearing member, and a transfer member for transferring the toner image from the image bearing member onto the recording material are provided. As the recording material carrying member, a transfer voltage constituted by an endless belt is used in many instances. Further, onto the recording material electrostatically attracted to this transfer belt and fed by this transfer belt, the toner images are successively transferred from the plurality of image bearing members disposed and arranged along a movement direction of the recording material by the recording material carrying member. As the transfer member, a transfer roller or the like provided on a side opposite from the image bearing member while sandwiching the transfer belt therebetween is used, and the transfer of the toner image is carried out by applying a transfer voltage to the transfer member.

As this cleaning means, the following cleaning means has been known. A cleaning roller is provided as a cleaning member contacting the image bearing member, and during image formation, the transfer residual toner is deposited on the cleaning roller and is temporarily collected. By this, occurrence of an image defect due to the influence of the transfer residual toner on a subsequent image forming process is suppressed. Further, the transfer residual toner temporarily collected by the cleaning roller is discharged from the cleaning roller onto the image bearing member at a predetermined timing during non-image formation. Then, the transfer residual toner discharged on the image bearing member is collected in a developing device. The transfer residual toner collected in the developing device is re-used for developing an electrostatic latent image into a toner image.

Heretofore, even when the foreign matter in the slight amount moved to the downstream-side image bearing member is carried on the image bearing member or on the cleaning roller, for example, and is collected together with the transfer residual toner in the developing device, a problem does not become obvious. However, in recent years, there is a tendency that the image bearing members and units including the developing devices, which are consumables, or the image forming apparatus are extended in lifetime. That is, there is a tendency that a total amount of the foreign matter moved to the downstream-side image bearing member increases. For that reason, there arose a possibility that the image defect occurs by the influence of the foreign matter moved to the downstream-side image bearing member without being completely moved to the most upstream image bearing member, even by the slight amount. This problem is conspicuous in a constitution in which the foreign matter collecting member is provided to only the most upstream image bearing member as described above, but this is true for the case where the foreign matter collecting member is also provided to the downstream-side image bearing member. As a result, the foreign matter is fixed to the image bearing member by being carried on the image bearing member for a long term, so that a stripe-like image defect, a dot-like image defect, or the like occurs on an image in some instances. Further, the foreign matter is carried on the cleaning roller for a long term, whereby the foreign matter is fixed to the image bearing member, so that a cleaning performance for the transfer residual toner lowers, and thus an image defect due to improper cleaning occurs in some instances. Further, for example, when an amount of the foreign matter collected together with the transfer residual toner in the developing device gradually increases and exceeds a certain threshold, an electric charge of the toner is disordered and causes the image defect in some instances.

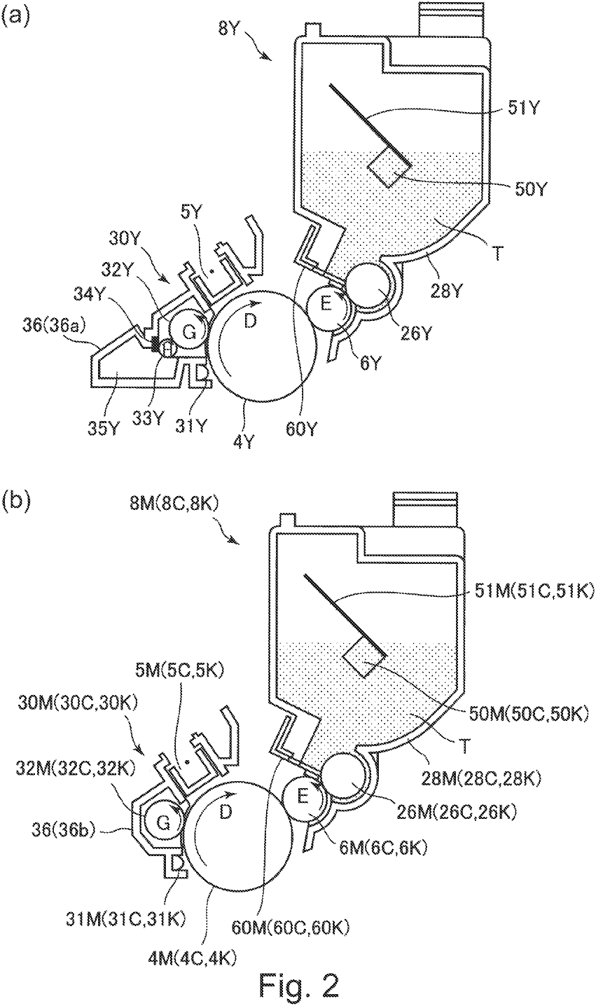

In the embodiment 1, each of the image forming portions P includes a photosensitive drum 4 which is a drum-type (cylindrical) photosensitive member (electrophotographic photosensitive member) as a rotatable image bearing member, a charging device (charging member) 5 (FIG. 2) as a charging means, and a developing device 8 as a developing means. Further, each image forming portion P includes a transfer roller 16 which is a roller-type transfer member as a transfer means, a discharging light source 31 (FIG. 2) as a discharging means, and a cleaning mechanism 36 (FIG. 2) as a cleaning means. The four image forming portions PY, PM, PC and PK are arranged and disposed in line along a movement direction of the recording material S by a transfer belt 12 (described later) (herein, also simply referred to as a “movement direction of the recording material S”). Further, in the embodiment 1, an exposure device 10 used as an exposure means in each image forming portion P is constituted as a single unit. Further, in the embodiment 1, in each image forming portion P, each of a drum unit 30 including the photosensitive drum 4 and the developing device (developing cartridge, developing unit) 8 is an exchangeable unit as a consumable.

Parts (a) and (b) of FIG. 2 are schematic sectional views each showing the drum unit 30 and the developing cartridge 8. Part (a) of FIG. 2 shows a drum unit 30Y and a developing cartridge 8Y of a most upstream image forming portion PY with respect to the movement direction of the recording material S. Part (b) of FIG. 2 shows drum units 30M, 30C and 30K and developing cartridges 8M, 8C and 8K of the image forming portions PM, PC and PK on sides downstream of the most upstream image forming portion PY with respect to the movement direction of the recording material S (herein, also simply referred to as a “downstream side”). Incidentally, as regards the plurality of image forming portions P and the elements thereof, “upstream” and “downstream” refer to “upstream” and “downstream” with respect to the movement direction of the recording material S. As shown in parts (a) and (b) of FIG. 2, in the embodiment 1, a constitution of the cleaning mechanism 36 is different between the most upstream drum unit 30Y and the downstream-side drum units 30M, 30C and 30K. The constitutions and operations of the drum unit 30 and the developing cartridge 8 will be specifically described later.

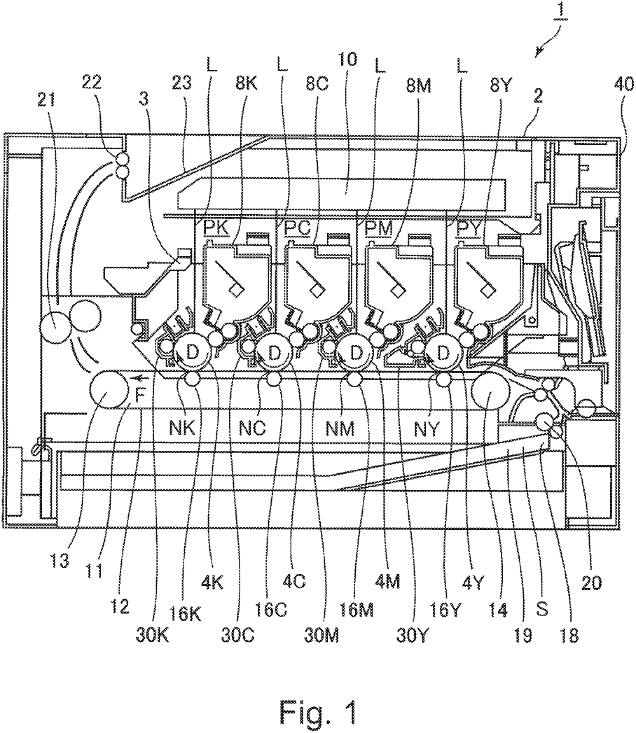

The electrostatic transfer device 11 is provided below the drum unit 30 and the developing cartridge 8 which are mounted in the cartridge tray 3. The electrostatic transfer device 11 includes the transfer belt 12 constituted by an endless belt as a recording material carrying member so as to contact the four photosensitive drums 4Y, 4M, 4C and 4K. As the transfer belt 12, a film-like member such as a resin film or a multi-layer film in which a resin layer is formed on a rubber base layer is used. The transfer belt 12 is stretched at a predetermined tension by being extended around a driving roller 13 and a follower roller 14, which are used as a plurality of stretching rollers (supporting rollers). Further, the transfer belt 12 electrostatically attracts a sheet-like recording material (recording medium, transfer material, sheet) S such as paper to an upper-side outer peripheral surface thereof in FIG. 1, and is circulated and moved so that the recording material S is successively contacted to the four photosensitive drums 4Y, 4M, 4C and 4K. On an inner peripheral surface side of the transfer belt 12, four transfer rollers 16Y, 16M, 16C and 16K are provided correspondingly to the four photosensitive drums 4Y, 4M, 4C and 4K, respectively. In the embodiment 1, the transfer rollers 16 are disposed opposed to the corresponding photosensitive drums 4 via the transfer belt 12, and are contacted to the photosensitive drums 4 via the transfer belt 12. By this, transfer portions NY, NM, NC and NK where the photosensitive drums 4Y, 4M, 4C and 4K and the transfer belt 12 are in contact with each other are formed. Thus, the transfer belt 12 forms the transfer portions N in contact with the photosensitive drums 4, so that the recording material S is nipped and fed between the transfer belt 12 and the photosensitive drums 4 in the transfer portions N. During transfer, to the transfer rollers 16, a predetermined transfer voltage (transfer bias) is applied, so that an electric charge is applied to the recording material S via the transfer belt 12. By an electric field generated at this time, onto the recording material S during contact with the photosensitive drum 4, the toner image on the photosensitive drum 4 is transferred. In the embodiment 1, the transfer roller 16 is constituted by coating, around a roller shaft formed of metal or the like, a sponge layer formed of a sponge material (a foamed rubber material such as foamed polyurethane) as an elastic layer.

The sheet feeding unit 18 is provided below the electrostatic transfer device 11. The sheet feeding unit 18 includes a sheet feeding tray 19 as a recording material accommodating portion in which recording materials S are stacked and accommodated, and a sheet feeding roller 20 as a feeding member.

Further, the discharging unit 22 discharges, onto a discharge tray 23, the recording material S passed through the fixing device 21.

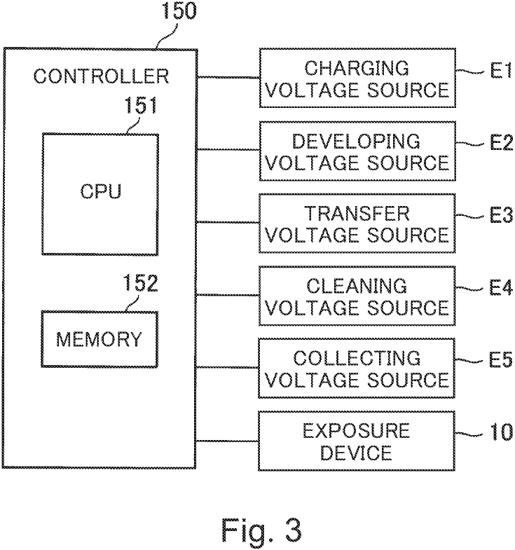

The first cleaning mechanism 36a includes cleaning roller 32 as a cleaning member for cleaning the surface of the photosensitive drum 4, and a foreign matter collecting roller 33 as a foreign matter collecting member for collecting a foreign matter deposited on the cleaning roller 32. Further, the first cleaning mechanism 36a includes a scraping member 34 as a foreign matter removing member, and a foreign matter collecting container 35 as an accommodating portion. Further, as shown in part (b) of FIG. 2, each of downstream-side drum units 30M, 30C and 30K includes a second cleaning mechanism 36b as the cleaning mechanism 36. The second cleaning mechanism 36b includes the cleaning roller 32 as the cleaning member. In the embodiment 1, the second cleaning mechanism 36b does not include the foreign matter collecting roller 33, the scraping member 34, and the foreign matter collecting container 35 which are provided in the first cleaning mechanism 36a. Incidentally, in the embodiment 1, in the first cleaning mechanism 36a, the cleaning roller 32 is connected to a cleaning voltage source E4 (FIG. 3), and the foreign matter collecting roller 33 is connected to a collecting voltage source E5 (FIG. 3). Further, in the second cleaning mechanism 36b, the cleaning roller 32 is connected to the cleaning voltage source E4 (FIG. 3).

As shown in parts (a) and (b) of FIG. 2, the developing cartridge 8 includes a developing frame (developing container) 28 for accommodating toner T as a developer, and a developing roller 6 as a rotatable developer carrying member for carrying the toner T on the surface thereof. Further, the developing cartridge 8 includes a supplying roller 26 as a developer supplying member for supplying the toner T to the developing roller 6, and a regulating blade 60 as a developer regulating member for regulating a layer thickness of the toner T carried on the surface of the developing roller 6. Further, the developing cartridge 8 includes, as a stirring/feeding member for stirring and feeding the toner T in the developing frame 28, a rotatable stirring shaft 50 and a stirring sheet 51 fixed to this stirring shaft 50. In the embodiment 1, the toner T is a non-magnetic, one-component developer.

The electrostatic latent image formed on the photosensitive drum 4 is developed (visualized) by being supplied with the toner by the developing cartridge 8, so that a toner image (developer image) depending on the image signal for the associated color is formed on the photosensitive drum 4. The toner T in the developing frame 28 is fed toward the supplying roller 26 while being circulated in the developing frame 28 by the stirring sheet 51 fixed to the stirring shaft 50. The supplying roller 26 supplies the toner T toward the developing roller 6. The developing roller 6 is constituted by coating, around a roller shaft (axis) formed of metal or the like, a rubber layer formed of a rubber material as an elastic layer. As the rubber layer, a solid rubber member or a sponge member, each of which has elasticity, is used. In the embodiment 1, the developing roller 6 contacts the photosensitive drum 4. The supplying roller 26 is constituted by coating, around a roller shaft (axis) formed of metal or the like, a sponge layer formed of a sponge material (foamed rubber material such as foamed polyurethane) as the elastic layer. In the embodiment 1, the supplying roller 26 contacts the developing roller 6. The developing roller 6 is rotationally driven in an arrow E direction (counterclockwise direction) in FIG. 2 at a predetermined peripheral speed. That is, the developing roller 6 is rotated so that the photosensitive drum 4 and the developing roller 6 move in the same direction at a contact portion therebetween. In the embodiment 1, the developing roller 6 is rotationally driven by a driving force which is transmitted from the driving motor (not shown) for driving the photosensitive drum 4 and which is branched. The developing roller 6 may be rotationally driven with a peripheral speed difference (for example, the developing roller 6 is rotated faster than the photosensitive drum 4) relative to the photosensitive drum 4 or may also be rotationally driven at the same peripheral speed as the photosensitive drum 4. The toner T supplied to the developing roller 6 enters between the developing roller 6 and the regulating blade 60 and is carried as a thin layer with a certain thickness on the developing roller 6. The toner T is charged to a predetermined polarity (positive polarity in the embodiment 1) by triboelectric charge between the regulating blade 60 and the developing roller 6 or between the supplying roller 26 and the developing roller 6. That is, in the embodiment 1, a normal charge polarity (“normal polarity”) of the toner T which is a charge polarity during development is the positive polarity. The regulating blade 60 is constituted by bonding a resin member to a metal plate formed of stainless steel or the like.

By a shape or a material of the resin member, a pressure applied to the toner T entered between the developing roller 6 and the regulating blade 60, and a triboelectric charge amount of the toner T are capable of being controlled. As the resin member, a silicone rubber or a urethane rubber is used.

The toner T carried on the developing roller 6 and charged to the positive polarity is supplied to the electrostatic latent image formed on the photosensitive drum 4. By this, the toner T is deposited on an image portion of the electrostatic latent image, so that the toner image is formed on the photosensitive drum 4. Further, to the developing roller 6, a predetermined developing voltage (developing bias) is applied by a developing voltage source E2 (FIG. 3) as a developing voltage applying portion. In the embodiment 1, the developing voltage source E2 applies, to the developing roller 6, a DC voltage of the positive polarity as the developing voltage. The developing voltage is set at a potential between an image portion potential and a non-image portion potential on the photosensitive drum 4. That is, the potential of the electrostatic latent image is larger in absolute value than the voltage applied to the developing roller 6 at the non-image portion where the toner T is not deposited (i.e., the image is not formed), and is smaller in absolute value than the voltage applied to the developing roller 6 at the image portion where the toner T is deposited (i.e., the image is formed). By this setting, the toner T charged to the positive polarity is moved from the developing roller 6 to the image portion of the electrostatic latent image formed on the photosensitive drum 4. Thus, in the embodiment 1, on an exposure portion (image portion) on the photosensitive drum 4 lowered in absolute value of the potential by being exposed to light after being uniformly charged, the toner T charged to the same polarity (the positive polarity in the embodiment 1) as the charge polarity of the photosensitive drum 1 (reverse development) is deposited.

Further, at a predetermined control timing, recording materials S are separated and fed one by one by the sheet feeding unit 18. This recording material S is fed to the transfer belt 12 at a predetermined control timing so that a timing when a leading end of the toner image on the most upstream photosensitive drum 4Y moves to the transfer portion NY and a timing when the recording material S is fed to the transfer portion NY are synchronized with each other (image formation start positions coincide with each other). Onto the recording material S electrostatically attracted to the transfer belt 12 and fed by the transfer belt 12, the toner images are successively transferred from the photosensitive drums 4 by electric fields formed between the photosensitive drums 4 and the associated transfer rollers 16. During the transfer, to each of the transfer rollers 16, a predetermined transfer voltage (transfer bias) is applied by a transfer voltage source E3 (FIG. 3) as a transfer voltage applying portion. In the embodiment 1, the transfer voltage source E3 applies, to the transfer roller 16, a DC voltage of the negative polarity which is an opposite polarity to the normal polarity (the positive polarity in the embodiment 1) of the toner T, as the transfer voltage. By this, the toner T charged to the positive polarity can be electrically attracted to the recording material S side.

### Control Mode

FIG. 3 is a schematic block diagram showing a control mode of a principal part of the image forming apparatus 1 of the embodiment 1. The image forming apparatus 1 is provided with a controller 150. The controller 150 includes a CPU 151 as a calculation control means which is a central element for performing a calculating process, a memory (storing element) 152 such as a ROM, a RAM, or the like as a storing means, an input/output portion (not shown) for controlling transfer of signals between itself and each of various elements connected to the controller 150. In the RAM, a detection result of a sensor, a calculation result, and the like are stored, and in the ROM, a control program, a data table acquired in advance, and the like are stored.

Incidentally, in the embodiment 1, the charging voltage source E1, the developing voltage source E2, the transfer voltage source E3, and the cleaning voltage source E4 are independently provided for each of the image forming portions P. However, at least one of the charging voltage source E1, the developing voltage source E2, the transfer voltage source E3, and the cleaning voltage source E4 may also be common to a plurality of the image forming portions (or all the image forming portions P). Further, in the embodiment 1, the collecting voltage source E5 is provided for only the image forming portion PY.

The image forming apparatus 1 is, in the embodiment 1, capable of executing a job (printing operation) which is a series of operations for forming an image on a single recording material S or images on a plurality of recording materials S by a single start instruction from an external device such as a personal computer. The job generally includes an image forming step (printing step), a pre-rotation step, a sheet interval in the case where the images are formed on the plurality of the recording materials S, and a post-rotation step. The image forming step is a period in which formation of the electrostatic (latent) image on the photosensitive drum 1, development of the electrostatic image (toner image formation), transfer of the toner image, fixing of the toner image, and the like are carried out, and during image formation refers to this period. Specifically, the timing during the image formation is different at positions where the formation of the electrostatic image, the formation of the toner image, the transfer of the toner image, the fixing of the toner image, and the like are carried out. The pre-rotation is a period in which a preparatory operation before the image forming step is performed. The sheet interval step is a period corresponding to an interval between a current recording material S and a subsequent recording material S when the image forming step for forming the images on the plurality of recording materials S is continuously performed during continuous image formation. The post-rotation step is a period of a post-operation (preparatory operation) after the image forming step. During the non-image formation refers to a period other than during the image formation and includes the pre-rotation step, the sheet interval, and the post-rotation step which are described above, and further includes a pre-multi-rotation step which is a preparatory operation during turning-on of a power source of the image forming apparatus 1 or during restoration from a sleep state. In the embodiment 1, at a predetermined timing during the non-image formation, as described later, an operation such that the transfer residual toner deposited on the cleaning roller 32 is discharged from the cleaning roller 32 onto the photosensitive drum 4 is executed.

### Cleaning Mechanism

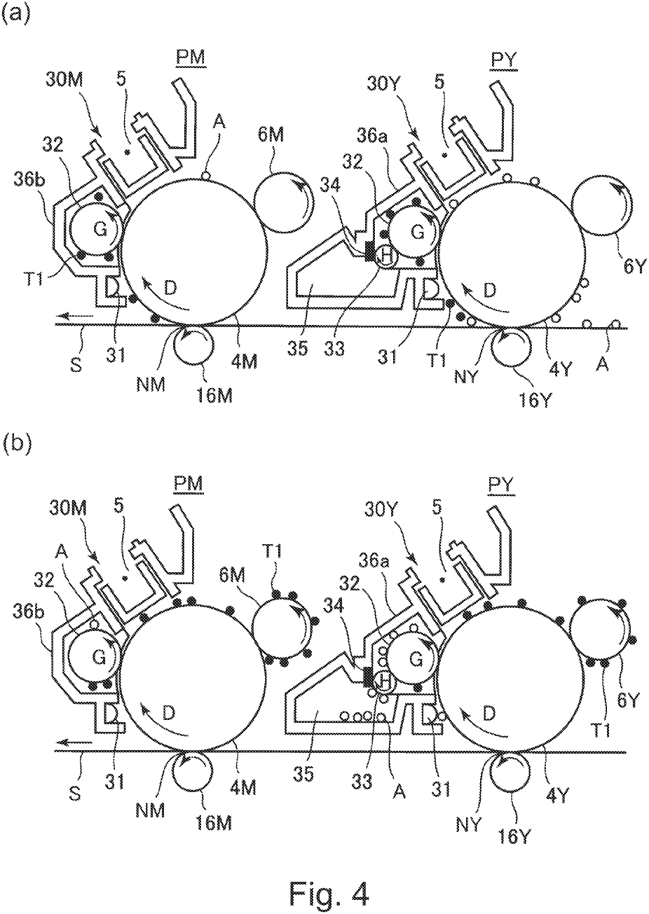

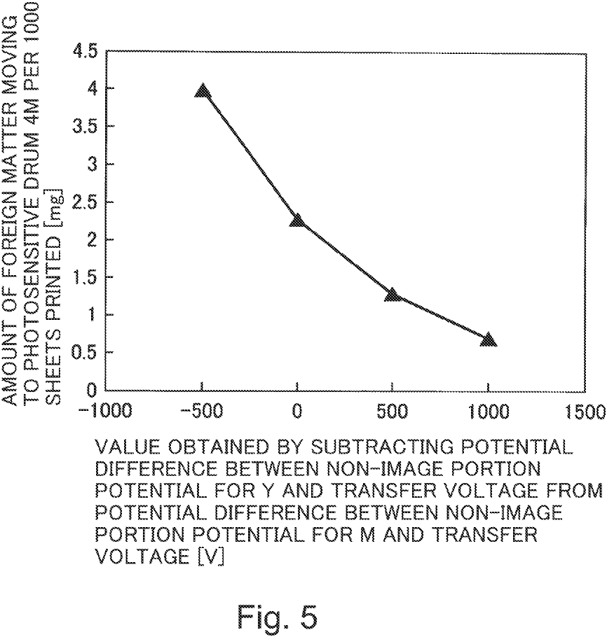

Next, the cleaning mechanism 36 in the embodiment 1 will be described in detail. Parts (a) and (b) of FIG. 4 are schematic views for illustrating the action of the cleaning mechanism 36 in the embodiment 1. Part (a) of FIG. 4 shows a state of the photosensitive drum 4Y of the most upstream image forming portion PY for Y and a periphery thereof when the toner T is transferred onto the recording material S (during the image formation) and shows a state of the photosensitive drum 4M of the image forming portion PM for M disposed downstream of and adjacent to the most upstream image forming portion PY and a periphery thereof during the image formation. Part (b) of FIG. 4 shows a state of the photosensitive drum 4Y of the most upstream image forming portion PY for Y and a periphery thereof at a time other than during the transfer (i.e., during the non-image formation) and shows a state of the photosensitive drum 4M of the image forming portion PM for M disposed downstream of and adjacent to the most upstream image forming portion PY and a periphery thereof during the image formation. In the following, as regards the downstream-side image forming portions PM, PC and PK, principally, the image forming portion PM for M will be described, but in the embodiment 1, constitutions and operations of the downstream-side image forming portions PM, PC and PK are substantially the same except that colors of the toners used for development are different from each other. Incidentally, in FIG. 4, for simplification, suffixes Y and M of reference numerals or symbols representing elements for associated colors are appropriately omitted. As described above, the most upstream image forming portion PY is provided with the first cleaning mechanism 36a as the cleaning mechanism 36. Further, the downstream-side image forming portion PM is provided with the second cleaning mechanism 36b as the cleaning mechanism 36.

As described above, the amount of the foreign matter A generated from the recording material S and moved to the photosensitive drum 4 is remarkably large in the material image forming portion PY and is small in the downstream-side image forming portion PM. However, in recent years, the drum unit 30 and the developing cartridge 8 which are used as consumables, and the image forming apparatus 1 tend to be extended in lifetime. As a result, the foreign matter A is carried on the photosensitive drum 4 and on the cleaning roller 32 for a long term, and causes sticking in the latter half or the like of the lifetime of the unit, the cartridge or the apparatus, so that a lowering in function of the photosensitive drum 4 or the cleaning roller 32 occurs in some instances. For example, when the foreign matter A sticks to the photosensitive drum 4, a stripe-like image defect or a dot-like image defect occurs on the image in some instances. Further, when the foreign matter A sticks to the cleaning roller 32, a cleaning performance for the transfer residual toner T1 lowers, so than an image defect due to improper cleaning occurs in some instances. Further, when the foreign matter A carried on the photosensitive drum 4 is, for example, collected together with the transfer residual toner T1 in the developing cartridge 8 and an amount thereof exceeds a certain threshold, a charging property of the toner T and a regulating force of the regulating blade 60 change, so that an electric charge of the toner T is disordered and the image defect is caused in some instances.

In general, as regards the image formed on the recording material S by the image forming apparatus 1, an area of the non-image portion is larger than an area of the image portion. Further, as regards the foreign matter A, in general, an amount thereof generated from a leading end and a trailing end, with respect to the feeding direction of the recording material S, corresponding to the non-image portions of the recording material S or from opposite end portions of the recording material S with respect to a widthwise direction (a direction substantially perpendicular to the feeding direction) is larger than an amount thereof generated from other portions. This is because the leading end, the trailing end, or the opposite end portions constitute cut surfaces when the recording materials S are manufactured, and therefore, the foreign matter generated during cutting exists in a large amount.

Next, another embodiment of the present invention will be described. Basic constitution and operation of an image forming apparatus of an embodiment 2 are same as those of the image forming apparatus of the embodiment 1. Accordingly, in the image forming apparatus of the embodiment 2, elements having functions or constitutions which are the same as or corresponding to those of the image forming apparatus of the embodiment 1 are omitted from detailed description by adding the same reference numerals or symbols as those in the embodiment 1. Further, also in the embodiment 2, as regards the downstream-side image forming portions PM, PC and PK, the image forming portion PM for M will be principally described. However, in the embodiment 2, constitutions and operations of the downstream-side image forming portions PM, PC and PK are substantially the same except that colors of toners used for development are different from each other.

However, when the transfer voltage applied to the transfer roller 16Y of the most upstream image forming portion PY is made larger than the transfer voltage applied to the transfer roller 16M of the downstream-side image forming portion PM by 1000 V in terms of an absolute value as described above, the following other problem arises. That is, the potential difference between the image portion on the photosensitive drum 4Y and the transfer roller 16Y in the most upstream image forming portion PY becomes larger than the potential difference between the image portion on the photosensitive drum 4M and the transfer roller 16M in the downstream-side image forming portion PM. For that reason, a transfer property of the toner image on the photosensitive drum 4Y of the most upstream image forming portion PY changes relative to a transfer property of the toner image on the photosensitive drum 4M of the downstream-side image forming portion PM, so that the transfer residual toner T1 increases at the most upstream image forming portion PY.

When the electric resistance of the transfer roller 16 is large, in comparison with the case where the electric resistance is small, a value of a current flowing through the transfer roller 16 becomes small even when the potential difference between the transfer roller 16 and the photosensitive drum 4 is made large. For that reason, the potential difference between the transfer roller 16 and the photosensitive drum 4 for causing a transfer current necessary to transfer the toner image to flow through the transfer roller 16 becomes large. As a result, even when the potential difference between the transfer roller 16Y and the photosensitive drum 4Y in the most upstream image forming portion PY is larger than the potential difference between the transfer roller 16M and the photosensitive drum 4M in the downstream-side image forming portion PM, it is possible to obtain high values of the transfer efficiency similar to each other between the most upstream image forming portion PY and the downstream-side image forming portion PM.

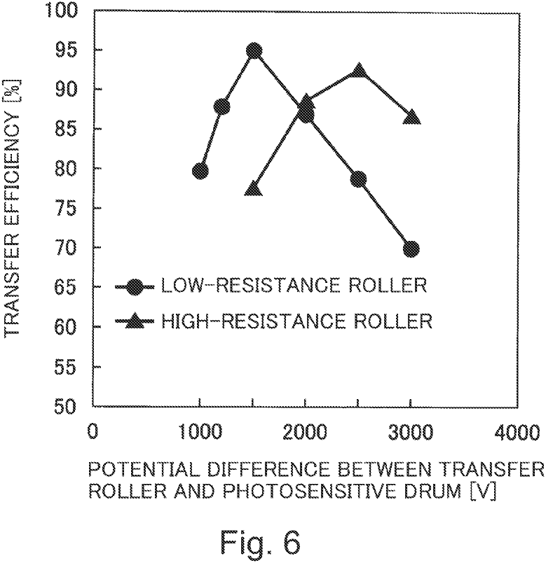

FIG. 6 is a graph showing the transfer efficiency relative to the potential difference between the transfer roller 16 and the photosensitive drum 4 in the case where transfer rollers 16 with two kinds of electric resistances (volume resistivities of sponge materials) are used. The recording material (paper) S used for printing is the Xerox multipurpose paper (basis weight: 75 g/m², LTR size) manufactured by Xerox Corp. Further, the transfer efficiency is determined when a solid image with a highest (image) density is transferred as the image. Incidentally, the transfer efficiency is represented by a percentage [%] by calculating a ratio of a weight of the toner T transferred on the recording material S to a weight of the toner T on the photosensitive drum 4.

Next, another embodiment of the present invention will be described. Basic constitution and operation of an image forming apparatus of an embodiment 3 are the same as those of the image forming apparatus of the embodiment 1. Accordingly, in the image forming apparatus of the embodiment 3, elements having functions or constitutions which are the same as or corresponding to those of the image forming apparatus of the embodiment 1 are omitted from detailed description by adding the same reference numerals or symbols as those in the embodiment 1. Further, also in the embodiment 3, as regards the downstream-side image forming portions PM, PC and PK, the image forming portion PM for M will be principally described. However, in the embodiment 2, constitutions and operations of the downstream-side image forming portions PM, PC and PK are substantially the same except that colors of toners used for development are different from each other.

In the embodiment 3, similarly as in the embodiment 2, different transfer voltages are applied to the transfer roller 16Y of the most upstream image forming portion PY and the transfer roller 16M of the downstream-side image forming portion PM (most upstream side: -2000 V, downstream side: -1000 V). For that reason, in the embodiment 3, similarly as in the embodiment 2, the potential difference between the image portion on the photosensitive drum 4Y and the transfer roller 16Y in the most upstream image forming portion PY becomes larger than the potential difference between the image portion on the photosensitive drum 4M and the transfer roller 16M in the downstream-side image forming portion PM. In the embodiment 3, the thus-caused problem of the change in transfer property between the most upstream image forming portion PY and the downstream-side image forming portion PM is solved by a means different from the means (constitution) in the embodiment 2.

Here, when printing is continued by using the photosensitive drum 4, the surface layer of the photosensitive drum 4 is abraded little by little by rubbing with the recording material S, the cleaning roller 32, the developing roller 6, the toner T, and the like. Even in an abrasion amount when the printing of the images on the number of sheets corresponding to the lifetime of the photosensitive drum 4 is carried out, it is desired that the film thickness of the surface layer of the photosensitive drum 4 in an initial stage (at the time of a brand-new state) is determined so as to satisfy the functions of the photosensitive drum 4. In the embodiment 3, in the photosensitive drum 4 of the most upstream image forming portion PY, the film thickness of the surface layer is made small, and therefore, in order to satisfy the function through the lifetime period, it is desired that the abrasion amount of the surface layer is made small.

For that reason, in the embodiment 3, as the material of the surface layer of the photosensitive drum 4Y of the most upstream image forming portion PY, a material which is less abraded than the material of the surface layer of the photosensitive drum 4M of the downstream-side image forming portion PM is used. In the embodiment 3, in the most upstream image forming portion PY and the downstream-side image forming portion PM, as the photosensitive drum 4, a photosensitive member of a single layer type which is an organic photosensitive member of which charge polarity is the positive polarity is employed. That is, this photosensitive drum 4 is constituted by forming, around a cylindrical substrate formed of an electroconductive material such as metal, the surface layer of a single layer which is a photosensitive layer principally formed of a resin material. Further, in the embodiment 3, the photosensitive drum 4Y of the most upstream image forming portion PY uses, as the binder resin material of the surface layer thereof, a polycarbonate resin of about 50,000 in average molecular weight. On the other hand, the photosensitive drum 4M of the downstream-side image forming portion PM uses, as the binder resin material of the surface layer thereof, a polycarbonate resin of about 20,000 in average molecular weight.

On the other hand, the surface layer of the photosensitive drum 4M of the downstream-side image forming portion drum is abraded by about 10 µm from an initial film thickness in the last stage of the lifetime thereof. As described above, in the embodiment 3, the initial film thickness of the surface layer of the photosensitive drum 4 is 25 µm for the photosensitive drum 4Y of the most upstream image forming portion 4Y and is 30 µm for the photosensitive drum 4M of the downstream-side image forming portion PM. For that reason, the film thickness of the surface layer remaining in the last stage of the lifetime is about 20 µm for the photosensitive drum 4 of each of the most upstream image forming portion PY and the downstream-side image forming portion PM, and thus is substantially the same.

Next, another embodiment of the present invention will be described. Basic constitution and operation of an image forming apparatus of an embodiment 4 are the same as those of the image forming apparatus of the embodiment 1. Accordingly, in the image forming apparatus of the embodiment 4, elements having functions or constitutions which are the same as or corresponding to those of the image forming apparatus of the embodiment 1 are omitted from detailed description by adding the same reference numerals or symbols as those in the embodiment 1. Further, also in the embodiment 4, as regards the downstream-side image forming portions PM, PC and PK, the image forming portion PM for M will be principally described. However, in the embodiment 4, constitutions and operations of the downstream-side image forming portions PM, PC and PK are substantially the same except that colors of toners used for development are different from each other.

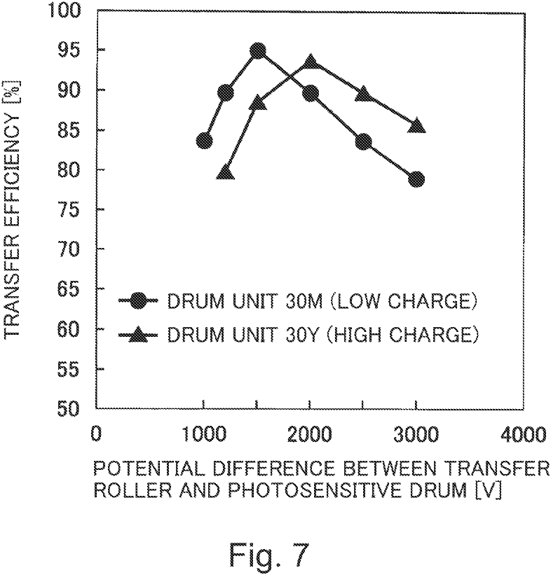

FIG. 7 is a graph showing the transfer efficiency relative to the potential difference between the transfer roller 16 and the photosensitive drum 4 in the case where two kinds of toners T are used. The recording material (paper) S used for printing is the Xerox multipurpose paper (basis weight: 75 g/m², LTR size) manufactured by Xerox Corp. Further, the transfer efficiency is determined when a solid image with a highest (image) density is transferred as the image. Further, the transfer efficiency is represented by a percentage [%] by calculating a ratio of a weight of the toner T transferred on the recording material S to a weight of the toner T on the photosensitive drum 4.

Incidentally, a means for increasing the electric charge amount of the toner T supplied to the photosensitive drum 4 is not limited to the means employed in the embodiment 4. For example, an external additive to the toner T may also be changed to an external additive when a high charging property is desired. Further, for example, the materials of the regulating blade 60 and the surface layer of the developing roller 6 may also be charged to materials high in chargeability to the toner T. Further, for example, to the regulating blade 60, by applying a voltage larger on the normal polarity side (the positive polarity side in the embodiment 4) than the potential of the developing roller 6, the chargeability to the toner T may also be improved.

1-10. (canceled)

11. An image forming apparatus capable of executing an image forming operation for forming an image on a recording material, said image forming apparatus comprising:
a first image forming portion including a rotatable first image bearing member having a surface layer formed on a surface thereof, a first charging member for electrically charging the surface of said first image bearing member, a first developing member for supplying a first developer to the surface of said first image bearing member, a first transfer member for transferring the first developer, supplied to the surface of said first image bearing member, onto a recording material, a first cleaning member in contact with said first image bearing member for cleaning the surface of said first image bearing member, and a foreign matter collecting member in contact with said first cleaning member for collecting foreign matter deposited on said first cleaning member;
a second image forming portion including a rotatable second image bearing member having a surface layer formed on a surface thereof, a second charging member for electrically charging the surface of said second image bearing member, a second developing member for supplying a second developer to the surface of said second image bearing member, a second transfer member for transferring the second developer, supplied to the surface of said second image bearing member, onto a recording material, and a second cleaning member in contact with said second image bearing member for cleaning the surface of said second image bearing member;
a belt configured to form a first transfer portion in contact with said first image bearing member and to form a second transfer portion in contact with said second image bearing member, said belt nipping and feeding the recording material between said belt and said first image bearing member at the first transfer portion and between said belt and said second image bearing member at the second transfer portion;
a charging voltage applying portion configured to apply a first charging voltage to said first charging member and to apply a second charging voltage to said second charging member; and
a transfer voltage applying portion configured to apply a first transfer voltage to said first transfer member and to apply a second transfer voltage to said second transfer member,
wherein with respect to a movement direction of the recording material, said first image forming portion is provided upstream of said second image forming portion,
wherein in the image forming operation, an absolute value of the first transfer voltage is greater than an absolute value of the second transfer, and
wherein a first layer thickness of the surface layer of the first image bearing member is thinner than a second layer thickness of the surface layer of the second image bearing member.

12. The image forming apparatus according to claim 11, wherein said second image forming portion is not provided with a foreign matter collecting member.

13. The image forming apparatus according to claim 11, wherein in the image forming operation, a difference at the first transfer portion between a potential at which the image to be formed on said first image bearing member is formed and the potential at which the image is not formed is greater than a difference at the second portion between a potential at which the image to be formed on said second image bearing member is formed and the potential at which the image is not formed.

14. The image forming apparatus according to claim 11, wherein in the image forming operation, a potential difference at the first transfer portion between a potential at which the image to be formed on said first image bearing member is formed and the first transfer voltage is greater than a potential difference at the second transfer portion between a potential at which the image to be formed on said second image bearing member is formed and the second transfer voltage.

15. The image forming apparatus according to claim 14, wherein each of said first transfer member and said second transfer member comprises a roller including an elastic layer formed around a shaft, and
wherein a volume resistivity of a material of said elastic layer constituting said first transfer member is greater than volume resistivity of a material of said elastic layer constituting said second transfer member.

16. The image forming apparatus according to claim 14, wherein a total electric charge amount per unit area of the first developer for forming a solid image on said first image bearing member is greater than a total electric charge amount per unit area of the second developer for forming a solid image on said second image bearing member.

17. The image forming apparatus according to claim 11, wherein an average molecular weight of a binder resin material constituting the surface layer of said first image bearing member is greater than an average molecular weight of a binder resin material constituting the surface layer of said second image bearing member.

18. The image forming apparatus according to claim 11, wherein an average particle size of the first developer is larger than an average particle size of the second developer.

19. The image forming apparatus according to claim 11, wherein the first charging voltage is greater than the second charging voltage.
